(19) United States
(12) Patent Application Publication
(10) Pub. No.: US 2016/0215607 A1
(43) Pub. Date: Jul. 28, 2016

(54) MONTE CARLO AUTOMATED REFRACTURE SELECTION TOOL

(71) Applicants: Casee Ryanne Lemons, The Woodlands, TX (US); Roland Illerhaus, The Woodlands, TX (US)

(72) Inventors: Casee Ryanne Lemons, The Woodlands, TX (US); Roland Illerhaus, The Woodlands, TX (US)

(73) Assignee: BAKER HUGHES INCORPORATED, HOUSTON, TX (US)

(21) Appl. No.: 14/604,238

(22) Filed: Jan. 23, 2015

(51) Int. Cl. E21B 47/00; G01V 99/00

(52) U.S. Cl. CPC E21B 47/00; G01V 99/00

(57) ABSTRACT

A method and computer-readable medium for selecting a wellbore for refracture is disclosed. A parameter is selected that is related a refracture decision and an influence value of the parameter on the refracture decision is determined. A first refracture score is estimated for a first wellbore based on a value of the parameter for the first wellbore and the influence value of the parameter. A second refracture score is estimated for a second wellbore based on a value of the parameter for the second wellbore and the influence value of the parameter. One of the first wellbore and the second wellbore is selected for refracture based on a comparison of the first refracture score and the second refracture score.

### BACKGROUND OF THE DISCLOSURE

The present invention is related to wellbore refracture operations and, in particular, to a method for selecting a wellbore as a candidate for a refracture operation.

Drilling a well costs millions of dollars and has an associated risk that either nor or low production will result. On the other hand, existing wells are proven to provide oil production, although the level of oil production wanes over time. Stimulation and fracturing technology makes it possible to modify an existing well to increase or rejuvenate oil production, thereby lowering both cost and risk. Thus, the refracture of existing wells presents itself as an economical alternative to drilling new wells. However, not all wells are suitable for the mechanical risk and cost risk associated with restimulation and refracture. Therefore, it is a challenge to select a wellbore for refracture with a reasonable expectation of economic success.

### SUMMARY OF THE DISCLOSURE

In one aspect, the present disclosure provides a method for selecting a wellbore for refracture, including: selecting a parameter related a refracture decision; determining an influence value of the parameter on the refracture decision; estimating a first refracture score for a first wellbore based on a value of the parameter for the first wellbore and the influence value of the parameter; estimating a second refracture score for a second wellbore based on a value of the parameter for the second wellbore and the influence value of the parameter; and selecting one of the first wellbore and the second wellbore for refracture based on the first refracture score and the second refracture score.

In another aspect, the present disclosure provides a non-transitory computer-readable medium having a set of instructions stored thereon and accessed by a processor to perform a method for selecting a wellbore for refracture, the method including: selecting a parameter related a refracture decision; determining an influence value of the parameter on the refracture decision; estimating a first refracture score for a first wellbore based on a value of the parameter for the first wellbore and the influence value of the parameter; estimating a second refracture score for a second wellbore based on a value of the parameter for the second wellbore and the influence value of the parameter; and selecting one of the first wellbore and the second wellbore for refracture based on the first refracture score and the second refracture score. The parameter can include a plurality of parameters and the method may then determine influence values for the plurality of parameters, estimate a parameter score for each of the plurality of parameters, and sum the parameter scores to estimate the refracture score for the wellbore.

In yet another embodiment, the present disclosure provides a method for selecting a wellbore for refracture, including: selecting a parameter related the wellbore; determining an influence value for the parameter; estimating a refracture score for the wellbore based on a value of the selected parameter for the wellbore and the determined influence value; and selecting the wellbore for refracture using the refracture score.

### BRIEF DESCRIPTION OF THE DRAWINGS

For detailed understanding of the present disclosure, references should be made to the following detailed description, taken in conjunction with the accompanying drawings, in which like elements have been given like numerals and wherein:

FIG. 1 discloses a system suitable for performing methods disclosed herein for selecting a wellbore for a refracture operation;

FIG. 2 shows a diagram outlining various technical parameters affecting a decision to select a wellbore for a refracture operation;

FIG. 3 shows an illustrative interface for selecting one or more parameters for use in deciding whether or not to perform a refracture operation on a wellbore;

FIGS. 4A-4E show an interface for determining a total refracture score for a wellbore;

FIG. 5A-5C show an exemplary sensitivity chart that shows an amount of influence one or more parameters have on the decision-making process; and

FIG. 6 shows a flowchart illustrating a method of selecting a wellbore for refracture in one embodiment of the present disclosure.

### DETAILED DESCRIPTION OF THE DISCLOSURE

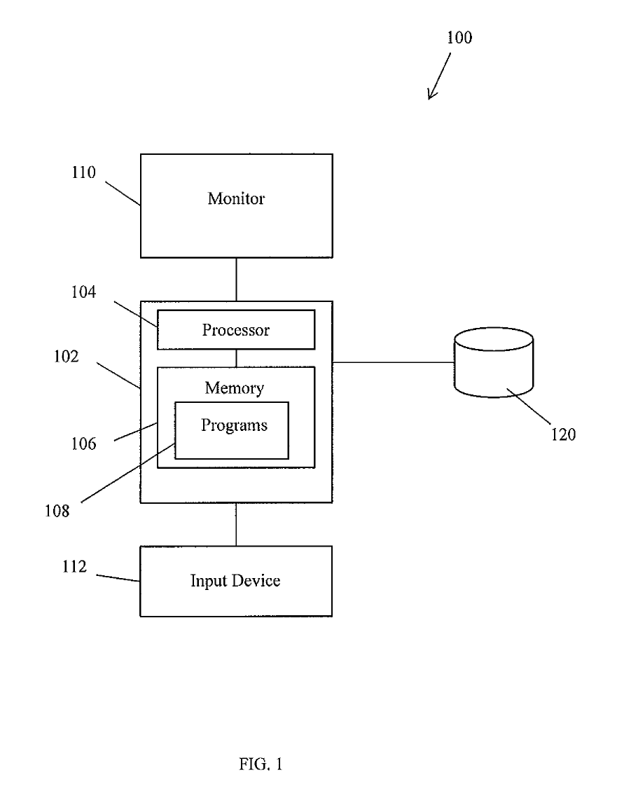

FIG. 1 discloses a system 100 suitable for performing methods disclosed herein for selecting a wellbore for a refracture operation. The system 100 includes a computer 102 that includes a processor 104 coupled to a memory storage device 106. The memory storage device 106 includes a non-transitory memory storage device such as solid state memory, etc. The memory storage device 106 includes a set of instructions or programs 108 accessible to the processor 102 which enable the processor 102 to perform a process of selecting a wellbore for refracture. The memory storage device 106 can further store parameter values that are used in the decision-making process. The processor 102 can also be in communication with one or more additional databases 120, such as third party databases and/or public domain databases. In general, the memory storage device 106 and the one or more additional databases 120 can include data related to wellbores, such as the various parameters discussed herein that are related to wellbore refracture, statistical values related to the parameter, etc. The processor 102 can further provide data and/or calculated results to a monitor 110 to display the data and/or calculated results to a user or operator. An input device 112, such as a keyboard, mouse etc. can be used to allow the user or operator to input values to the computer 102, access the database 120, etc.

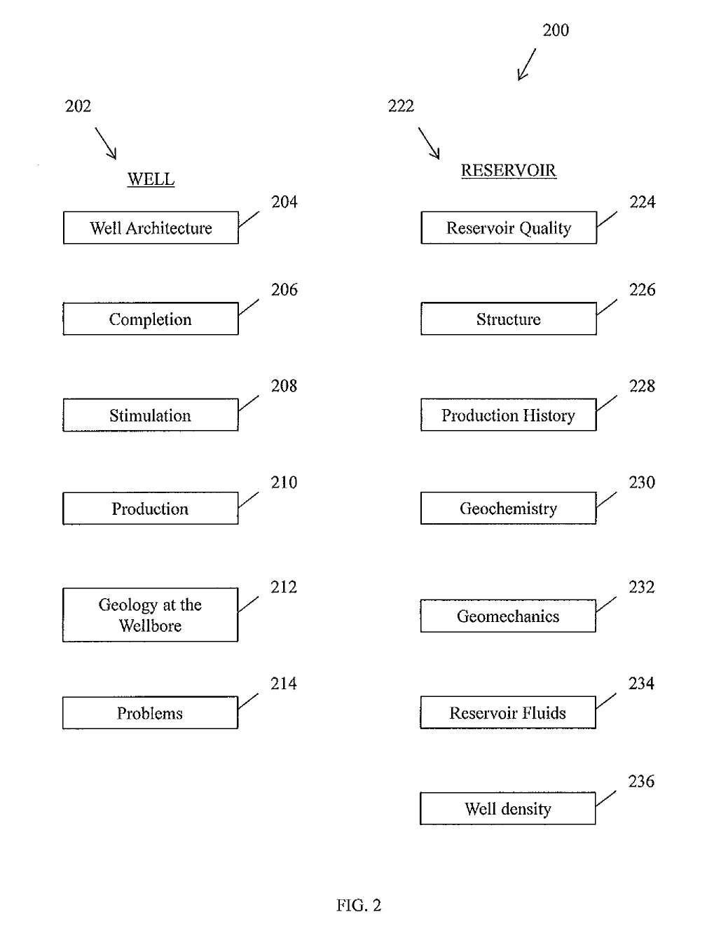

FIG. 2 shows a diagram 200 outlining various technical parameters affecting a decision to select a wellbore for a refracture operation. The technical parameters generally fall within one of two major categories: Wellbore parameters 202 and Reservoir parameters 222.

Wellbore parameters 202 include, but are not limited to, well architecture parameters 204, completion parameters 206, stimulation parameters 208, production parameters 210, geology parameters at the wellbore 212 and/or problems parameters 214 as well as logging parameters obtained during measurement-while-drilling operations, logging-while-drilling operations, wireline operations, etc. Well architecture parameters 204 include, for example, casing integrity, an azimuth of the well, a casing size such as an outer diameter of the casing, a lateral length of the wellbore and a maximum dog leg severity of the wellbore. Completion parameters 206 include, but are not limited to, whether or not the wellbore is cemented or uncemented, a cement bond, a cluster length, a number of clusters per stage, a cluster space, whether or not a completion diagnostics report has been performed, whether or not a microseismic diagnostics has been performed, a length of non-completed intervals, a reason for non-completed intervals, a time since latest completion date, a total perforated length, a perforation diameter, a number of perforations per cluster, a perforation phasing, a stage length and/or a completion method.

Stimulation parameters 208 include, but are not limited to, whether or not a flowback history has been reported, a fluid rate per cluster, an average injection rate, a percentage of fluid recovery, a fluid type, a proppant weight per stage, a strongest proppant type, a maximum proppant weight within all stages, a proppant type, a proppant staging total (i.e., a ratio of proppant weight per volume of treatment fluid), a total stimulated length, a total proppant weight per lateral foot, an average treatment fluid volume per stage, a total treatment fluid volume per lateral foot, and/or a number of different types of treatment fluids. Production parameters 210 include, but are not limited to: a 12-monthy cumulative gas production, a 12-month cumulative oil production and/or a 12-month cumulative water production. Geology parameters 212 at the wellbore include, but are not limited to: a bottomhole flowing pressure, a number of faults intersecting the wellbore, a formation hardness, a geochemistry report of the wellbore, a geomechanics report of the wellbore, a mineralogy report of the wellbore, an availability of a drilled core for examination, a current pressure gradient, an original pressure gradient, a pressure per cluster, and/or a zone thickness. Problem parameters 214 include, but are not limited to: a maximum degree of dog leg severity, a presence of hydrogen sulfide, a presence of paraffin, a presence of scaling, an occurrence of screenouts, a known hydraulic fracture barrier, and/or a presence of sulfate reducing bacteria.

Reservoir parameters 222 include, but are not limited to, reservoir quality parameters 224, reservoir structure parameters 226, production history parameters 228, geochemistry parameters 230, geomechanics parameters 232, reservoir fluid parameters 234 and/or well density parameters.

Reservoir quality parameters 224 include, but are not limited to: basin type, depositional environment, play type, lithology, permeability, porosity and/or temperature gradient, reservoir quality, an average clay content, an average quartz content, an average feldspar content, an average carbonate content and an average iron oxide content. Reservoir structure parameters 226 include, but are not limited to: a depth to the formation, a fault at or near the wellbore, an isopach map, a reservoir pinch out at or near the wellbore, and/or seismic data. Production history parameters 228 include, but are not limited to: a field average 12-month cumulative gas production, a field average 12-month cumulative oil production, and/or a field average 12-month cumulative water production. Geochemistry parameters 230 include, but are not limited to: a kerogen type, a geothermal gradient, a reservoir temperature, a thermal maturity and/or a Total Organic Carbon (TOC) values. Geomechanics parameters 232 include, but are not limited to: a horizontal stress anisotropy, a Brittleness Index, a Young's Modulus and/or a pore pressure gradient. Reservoir fluid parameters 234 include, but are not limited to: a gas saturation, an oil saturation, a water saturation, a gas/oil ratio, a gas/oil ratio map, the hydrocarbon(s) produced, whether the flow is single-phase or multi-phase, an oil gravity, a viscosity of oil and/or a viscosity of gas. Well density parameters 236 include, but are not limited to: a number of reservoirs in a field, a proximity to nearest offset well, and/or a spacing between wellbores.

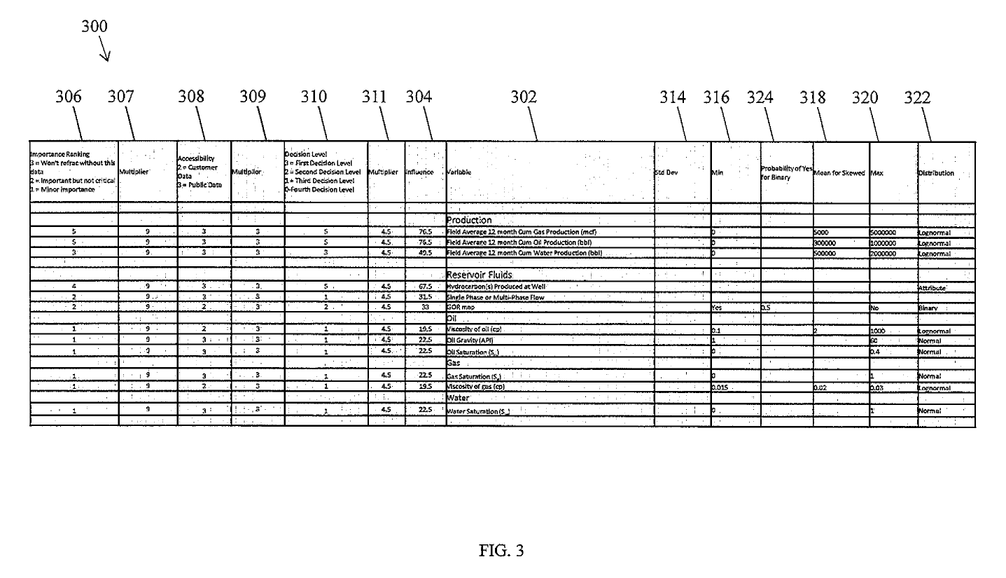

FIG. 3 shows an illustrative interface 300 for allowing a user or operator to select one or more parameters for use in deciding whether or not to perform a refracture operation on a wellbore. For illustrative purposes only, the interface 300 displays only well production parameters and reservoir fluids parameters (oil, gas, water). However, in various embodiments, the interface 300 includes one or more of the parameters listed above with respect to FIG. 2. The interface 300 may further include other parameters not listed herein. The operator uses the interface 300 to select which parameters will be used in selecting a wellbore from a plurality of wellbores for a refracture operation. The interface 300 can also be used to determine the amount of influence the parameter has in selecting the wellbore. The interface 300 includes a column 302 listing a plurality of the parameters such as the parameters listed above with respect to FIG. 2. To the left of the column 302, the operator is able to input various values which determine an amount of influence a parameter in column 302 has in the decision-making process, or in other words a weighting of the parameter in the decision-making process. To the right of the column 302 is shown values of various statistical variables related to the parameter.

The influence of a parameter is represented by an influence value that is displayed in column 304. For example, the influence value for the parameter of Field Average 12-month Cumulative Gas Production is 76.5. Rankings (columns 306, 308, 310) for the parameter determine the influence value (column 304) for the parameter. These rankings include an importance ranking (column 306), an accessibility ranking (column 308) and a decision level ranking (column 310). The importance ranking indicates how important the selected parameter is when deciding on whether or not to refracture a wellbore. In the illustrative embodiment, the value ‘3’ indicates that the decision to refracture will not be made without considering this parameter, the value ‘2’ indicates that the parameter is important to the decision-making process but not a critical parameter, and the value ‘1’ indicates that the parameter is of minor importance to the decision-making process. The accessibility ranking indicates a level of access the operator has to the related parameter data. For example, the value ‘3’ indicates that the data is customer data or proprietary data. The value ‘2’ indicates that the data is public data. The decision level ranking indicates a location in a decision tree of the decision-making process at which the parameter is implemented. In the illustrative embodiment, the value ‘3’ indicates that the parameter is used at a first decision level, the value ‘2’ indicates that the parameter is used at a second decision level, the value ‘1’ indicates that the parameter is used at a third decision level, and the value ‘0’ indicates that the parameter is used in a fourth decision level or higher.

To obtain the influence value for the selected parameter, each of the importance ranking 306, accessibility ranking 308 and decision level ranking 310 are multiplied by an associated multiplier (307, 309, 311) and then summed, as indicated below in Eq. (1):.

Influence Value=(Importance Ranking)*(Importance Multiplier)+(Accessibility Ranking)*(Accessibility Multiplier)+(Decision Level Ranking)* (Decision Level Multiplier) Eq. (1)

To determine the ranking values, the rankings (306, 308 and 310) are calibrated and validated to correspond with field data. A preliminary set of ranking values can be entered by people knowledgeable in the field. Then the model undergoes a series of Monte Carlo simulations (i.e., 20,000 iterations) in order to obtain various influence values. The various influence values obtained from the Monte Carlo simulations are compared to an expected outcome or a reality-based outcome to ensure that the rankings obtained via the simulations provide realistic influence scores. Once a realistic set of influence scores has been obtained the ranking values are set as constant values.

The statistical values to the right of column 302 are related to a sample set of wellbores. In general, the sample set of wellbores includes those wellbores under consideration for refracture by the operator. For example, the sample set of wellbores can include the set of all land-based wellbores in North America. The statistical data is generally obtained from an outside database, such as database 120 in FIG. 1. The statistical data for a selected parameter include, for example, standard deviation 314, minimum value 316, mean value 318 and maximum value 320. Column 322 lists the type of distribution for the parameter and column 324 lists a probability of YES. Column 324 has a value only when the type of distribution in column 322 is a binary distribution.

Therefore, at interface 300 the operator selects one or more of the listed parameters. The operator can enter statistical values for the selected parameters. Alternatively, the statistical parameters can be retrieved from database 120 either automatically or when the operator selects a command to retrieve the statistical parameter. As discussed below, values of the parameters for a selected wellbore, the influence values of the parameters and the statistical data for the parameter for the sample set of wellbores are used to obtain a total refracture score for the wellbore. The total refracture score indicates a degree of confidence or expectation of success for successful oil production from the wellbore using a refracture operation.

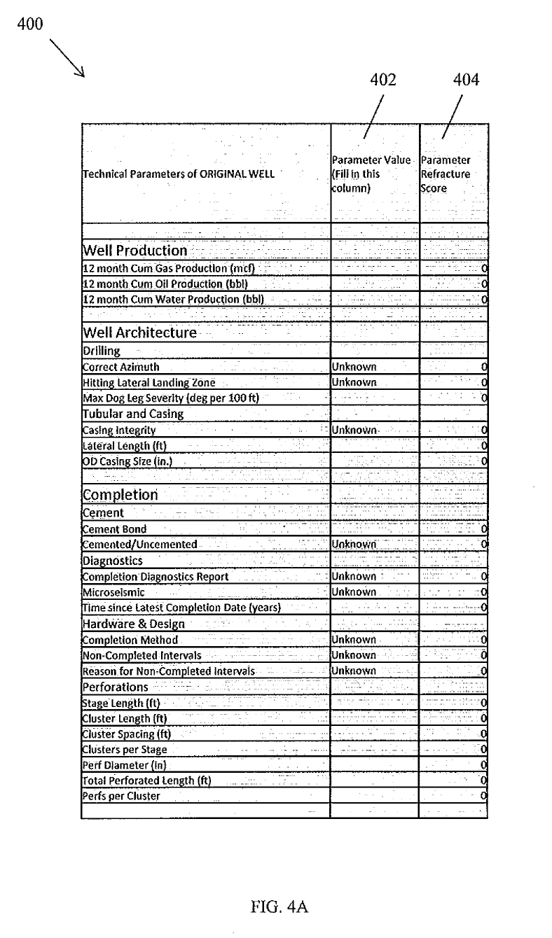

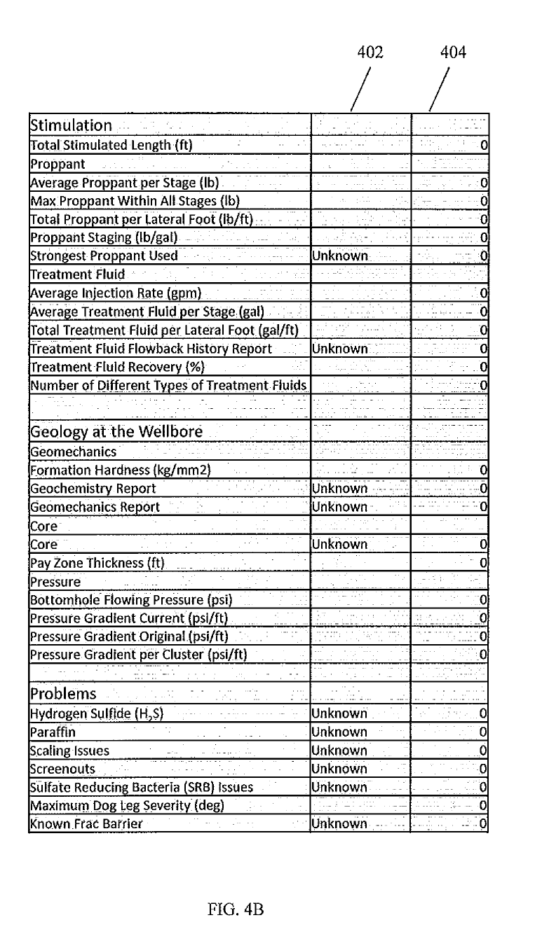

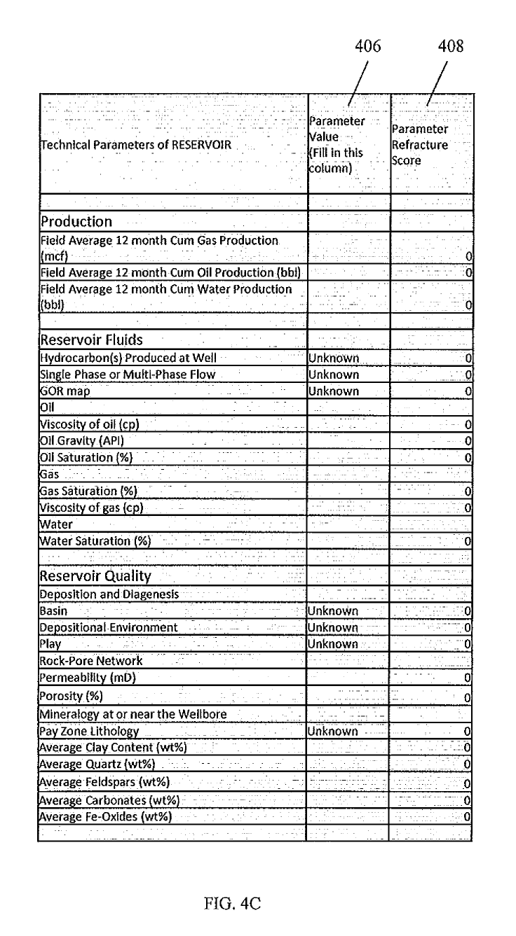

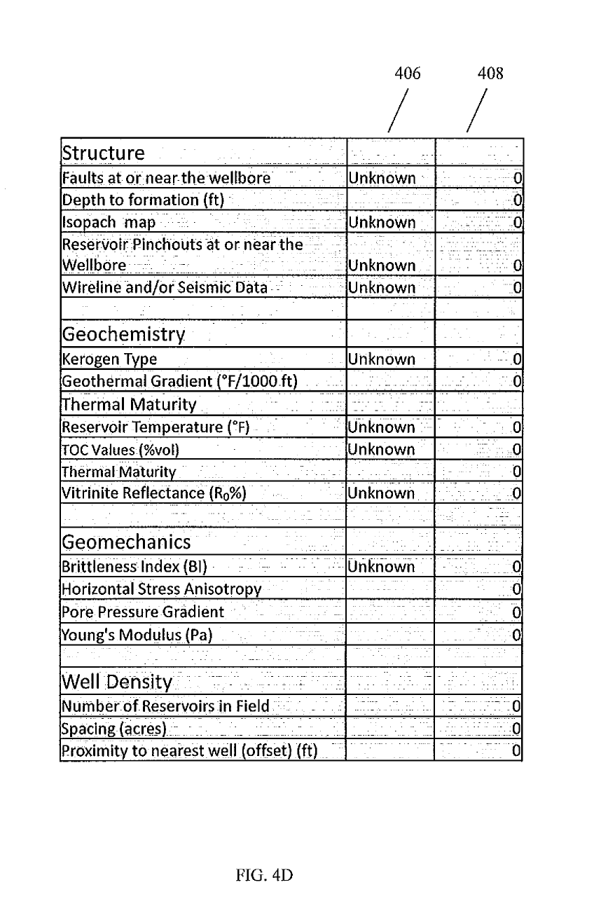

FIGS. 4A-4E show parts of an interface 400 at which the operator can determine a total refracture score for a wellbore. FIGS. 4A-4B show a table in which the operator can enter parameter values for technical parameters of the well in order to obtain parameters scores for the technical parameters of the well. FIGS. 4C-4D show a table in which the operator can enter parameter values for technical parameters of the reservoir in order to obtain parameters scores for the technical parameters of the reservoir. FIG. 4E shows a table of refracture scores. Looking first at FIGS. 4A-4D, the operator inputs values (column 402, column 406) of parameters for the selected wellbore. The input values can be either numerical values or attribute entries. The attribute entries may be presented in a drop-down box. An attribute entry may have an associated numerical value. The entered input values are sent to the processor (102, FIG. 1) which normalizes the input values (402, 406) against its corresponding statistical variable. The input values can then be adjusted for negative or positive influence, and multiplied by their corresponding influence value (column 304, FIG. 3) to obtain a parameter score (column 404, column 408). For an attribute entry, the influence value associated with the selected attribute entry is used. The associated influence value can be a positive value, which results in a positive parameter score, or a negative value, which results in a negative parameter score. Parameter scores are determined for each of the selected parameters and the parameters scores are then summed to obtain the total refracture score 414 (FIG. 4E).

As shown in the exemplary interface 400, the values of well parameters are entered into column 402 and the values of reservoir parameters are entered in column 406. The parameter scores in the first column 404 can be summed to obtain a well refracture score 410 (FIG. 4E). The parameter scores in the second column 408 can be summed to obtain a reservoir refracture score 412 (FIG. 4E). The total refracture score 414 is the sum of the well refracture score 410 and the reservoir refracture score 412.

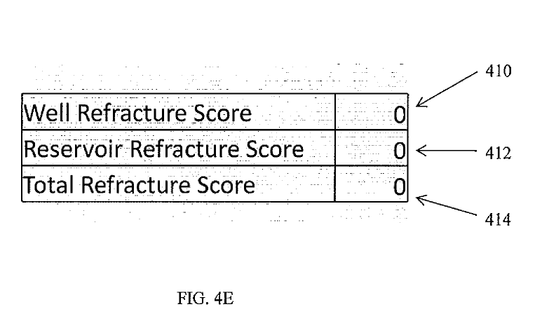

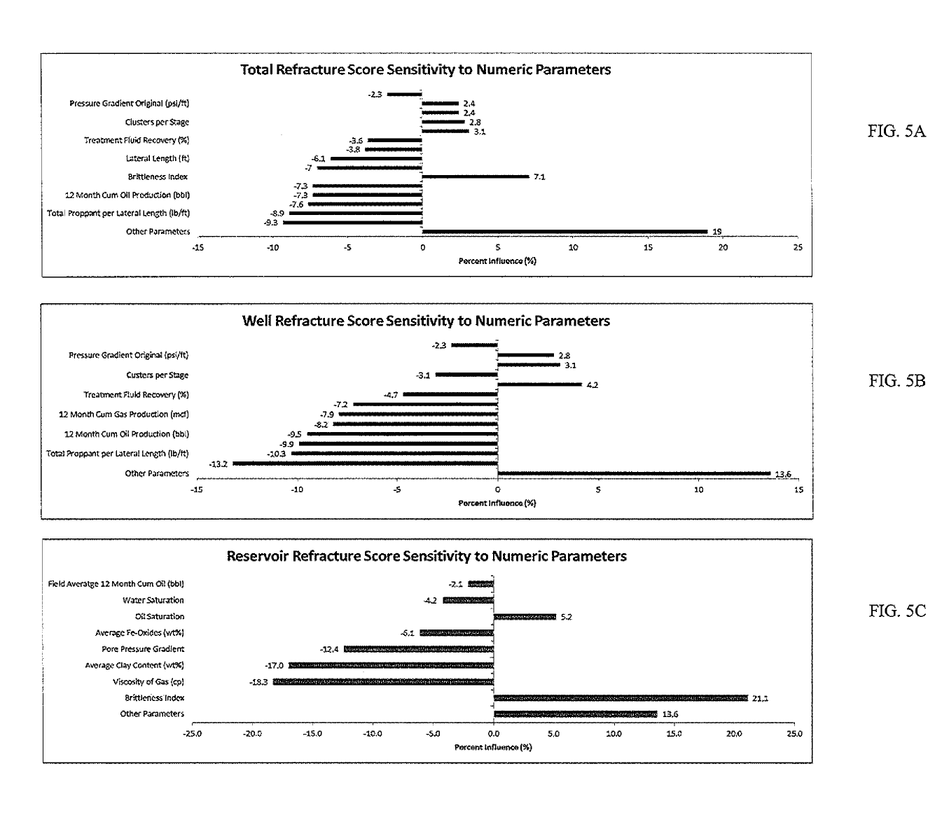

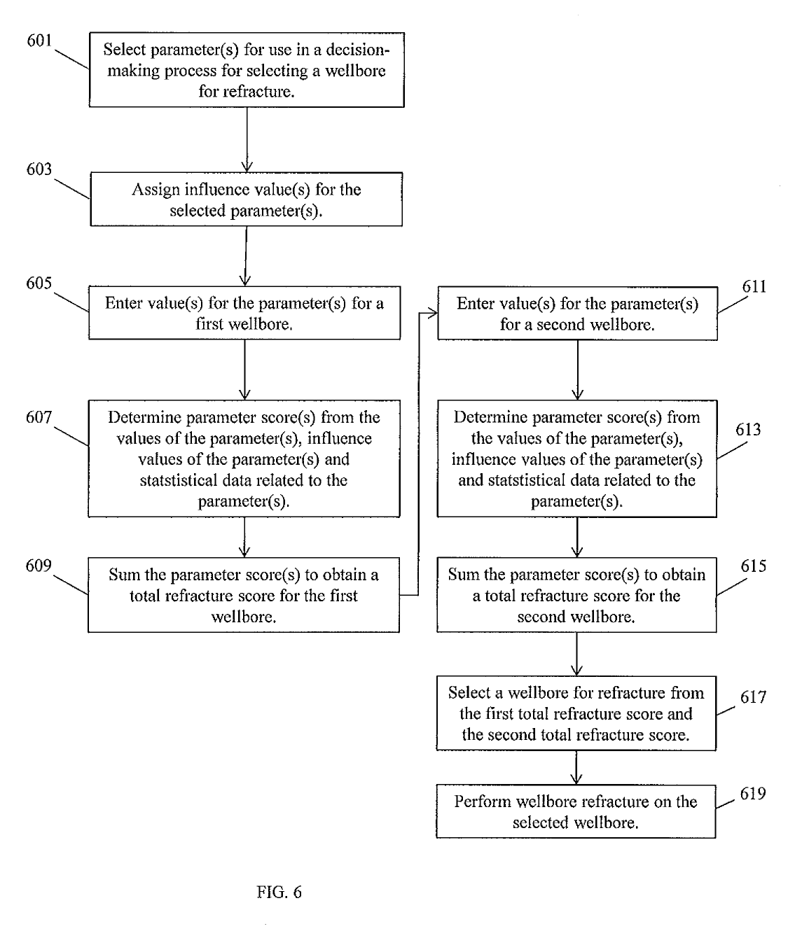

FIGS. 5A-5E show exemplary sensitivity charts that shows an amount of influence one or more parameters have on the decision-making process. FIG. 5A shows an exemplary sensitivity of the total refracture score to numeric parameters. FIG. 5B shows an exemplary sensitivity of the well refracture score to numeric parameters. FIG. 5C shows an exemplary sensitivity of the reservoir refracture score to numeric parameters.

FIG. 6 shows a flowchart 600 illustrating a method of selecting a wellbore for refracture in one embodiment. In Box 601, one or more parameters are selected for use in a decision-making process. In Box 603, influence values are assigned to the one or more parameters (via Monte Carlo simulation). In Box 605, values of the parameters for a first wellbore are entered into the interface 400. In Box 607, parameter scores for the first wellbore are determined using the entered values of the parameters, the influence values for the parameters and statistical values for the parameters. In Box 609, the parameter scores for the first wellbore are summed to obtain a first total refracture score for the first wellbore. In Box 611, values of the parameters for a second wellbore are entered into the interface 400. In Box 613, parameter scores for the second wellbore are determined using the entered values of the parameters, the influence values for the parameters and statistical values for the parameters. In Box 615, the parameter scores for the second wellbore are summed to obtain a second total refracture score for the second wellbore. In Box 617, the first total refracture score and the second total refracture score are compared to select one of the first wellbore and the second wellbore for a refracture operation. In one embodiment, the wellbore with the highest total refracture score is selected for the refracture operation. In another embodiment, wellbores having a total refracture score within a selected range of values are selected. In general, a high total refracture scores indicates that a wellbore has a higher probability of successful refracture, while a low total refracture score indicates that a wellbore has a lower probability of successful refracture. In Box 613, the wellbore refracture operation is performed on the selected wellbore.

The process of Boxes 605, 607 and 609 and of Boxes 611, 613 and 615 can be repeated to obtain a plurality of total refracture scores for a plurality of wellbores and the selected wellbore can be selected using the plurality of total refracture scores. Also, parameter scores may be summed to obtain well refracture scores and/or reservoir refracture scores and the selection of a wellbore for the refracture operation can be made by comparing well refracture scores and/or reservoir refracture scores.

Therefore in one aspect, the present disclosure provides a method for selecting a wellbore for refracture, including: selecting a parameter related a refracture decision; determining an influence value of the parameter on the refracture decision; estimating a first refracture score for a first wellbore based on a value of the parameter for the first wellbore and the influence value of the parameter; estimating a second refracture score for a second wellbore based on a value of the parameter for the second wellbore and the influence value of the parameter; and selecting one of the first wellbore and the second wellbore for refracture based on the first refracture score and the second refracture score. In an embodiment in which the parameter includes a plurality of parameters, the method further includes determining the influence values for the plurality of parameters, estimating a parameter score for each of the plurality of parameters and summing the parameter scores to estimate the refracture score for the wellbore. A parameter score for a parameter can be determined by selecting a value of the parameter, normalizing the value of the parameter against statistical values for the parameter and multiplying the normalized parameter value by the determined influence value. The statistical values can include a maximum value of the parameter for the sample set for wellbores, a minimum value of the parameter for the sample set for wellbores, a mean value of the parameter for the sample set for wellbores, a standard deviation of the parameter for the sample set for wellbores, a probability of “yes” for a binary distribution a distribution type for the parameter, etc. In one embodiment, a Monte Carlo simulation can be used to obtain a ranking associated with a parameter. The ranking of the parameter can be multiplied by a multiplier to determine the influence value for the parameter. The parameters can be wellbore parameters or reservoir parameters. Therefore, the wellbore parameter scores can be summed to obtain a well refracture score, and reservoir parameters scores can be summed to obtain a reservoir refracture score. The refracture score can be the reservoir refracture score, the wellbore refracture score or a sum of the reservoir refracture score and the wellbore refracture score. In one embodiment, the influence of the parameters can be ranked based on: (i) an importance of the parameter toward the refracture decision; (ii) an availability of the parameter; and (iii) a placement of the parameter in a decision-making process. Refracture is performed on the selected wellbore.

In another aspect, the present disclosure provides a non-transitory computer-readable medium having a set of instructions stored thereon and accessed by a processor to perform a method for selecting a wellbore for refracture, the method including: selecting a parameter related a refracture decision; determining an influence value of the parameter on the refracture decision; estimating a first refracture score for a first wellbore based on a value of the parameter for the first wellbore and the influence value of the parameter; estimating a second refracture score for a second wellbore based on a value of the parameter for the second wellbore and the influence value of the parameter; and selecting one of the first wellbore and the second wellbore for refracture based on the first refracture score and the second refracture score. The parameter can include a plurality of parameters and the method may then determine influence values for the plurality of parameters, estimate a parameter score for each of the plurality of parameters, and sum the parameter scores to estimate the refracture score for the wellbore. In one embodiment, determining a parameter score for a parameter includes entering a value for the selected parameter, normalizing the value of the selected parameter against statistical values for the selected parameter and multiplying the normalized parameter value by its associated influence value. The statistical values can include a maximum value of the parameter for the sample set for wellbores, a minimum value of the parameter for the sample set for wellbores, a mean value of the parameter for the sample set for wellbores, a standard deviation of the parameter for the sample set for wellbores, a probability of “yes” for a binary distribution a distribution type for the parameter, etc. A Monte Carlo simulation can be used to obtain a ranking associated with a parameter. The ranking can then be multiplied with an associated multiplier to determine the influence value for the parameter. The parameters can be wellbore parameters or reservoir parameters. Therefore, the wellbore parameter scores can be summed to obtain a well refracture score, and reservoir parameters scores can be summed to obtain a reservoir refracture score. The refracture score can be the reservoir refracture score, the wellbore refracture score or a sum of the reservoir refracture score and the wellbore refracture score. In one embodiment, the influence of the parameters can be ranked based on: (i) an importance of the parameter toward the refracture decision; (ii) an availability of the parameter; and (iii) a placement of the parameter in a decision-making process. Refracture is performed on the selected wellbore.

In yet another embodiment, the present disclosure provides a method for selecting a wellbore for refracture, including: selecting a parameter related the wellbore; determining an influence value for the parameter; estimating a refracture score for the wellbore based on a value of the selected parameter for the wellbore and the determined influence value; and selecting the wellbore for refracture using the refracture score. In one embodiment, estimating the refracture score includes normalizing the value of the selected parameter against statistical values for the selected parameter and multiplying the normalized parameter value by the determined influence value.

While the foregoing disclosure is directed to the preferred embodiments of the disclosure, various modifications will be apparent to those skilled in the art. It is intended that all variations within the scope and spirit of the appended claims be embraced by the foregoing disclosure.

What is claimed is:

1. A method for selecting a wellbore for refracture, comprising:
selecting a parameter related a refracture decision;
determining an influence value of the parameter;
estimating a first refracture score for a first wellbore based on a value of the parameter for the first wellbore and the influence value of the parameter;
estimating a second refracture score for a second wellbore based on a value of the parameter for the second wellbore and the influence value of the parameter; and
selecting one of the first wellbore and the second wellbore for refracture based on the first refracture score and the second refracture score.

2. The method of claim 1, wherein the parameter further comprises a plurality of parameters, further comprising determining influence values for the plurality of parameters, estimating a parameter score for each of the plurality of parameters and summing the parameter scores to estimate the refracture score for the wellbore.

3. The method of claim 2, wherein determining a parameter score for a parameter further comprises selecting a value of the parameter, normalizing the value of the parameter against statistical values for the parameter and multiplying the normalized parameter value by the determined influence value.

4. The method of claim 3, wherein the set of statistical values further includes at least one of: (i) a maximum value of the parameter for the sample set for wellbores; (ii) a minimum value of the parameter for the sample set for wellbores; (iii) a mean value of the parameter for the sample set for wellbores; (iv) a standard deviation of the parameter for the sample set for wellbores; and (v) a probability of “yes” for a binary distribution a distribution type for the parameter.

5. The method of claim 1, using a Monte Carlo simulation to obtain a ranking associated with a parameter and multiplying the ranking with a multiplier to determine the influence value for the parameter.

6. The method of claim 2, wherein the plurality of parameters includes wellbore parameters and reservoir parameters, further comprising at least one selected from the group consisting of: (i) summing wellbore parameter scores to obtain a well refracture score; and (ii) summing reservoir parameter scores to obtain a reservoir refracture score.

7. The method of claim 6, wherein the refracture score is one of: (i) the reservoir refracture score; (ii) the wellbore refracture score; and (iii) a sum of the reservoir refracture score and the wellbore refracture score.

8. The method of claim 1 further comprising ranking the influence of the parameter based on at least one of: (i) an importance of the parameter toward the refracture decision; (ii) an availability of the parameter; and (iii) a placement of the parameter in a decision-making process.

9. The method of claim 8, further comprising performing refracture on the selected wellbore.

10. A non-transitory computer-readable medium having a set of instructions stored thereon and accessed by a processor to perform a method for selecting a wellbore for refracture, the method comprising:
selecting a parameter related a refracture decision;
determining an influence value of the parameter;
estimating a first refracture score for a first wellbore based on a value of the parameter for the first wellbore and the influence value of the parameter;
estimating a second refracture score for a second wellbore based on a value of the parameter for the second wellbore and the influence value of the parameter; and
selecting one of the first wellbore and the second wellbore for refracture based on the first refracture score and the second refracture score.

11. The computer-readable medium of claim 10, wherein the parameter further comprises a plurality of parameters, the method further comprising determining influence values for the plurality of parameters, estimating a parameter score for each of the plurality of parameters and summing the parameter scores to estimate the refracture score for the wellbore.

12. The computer-readable medium of claim 11, wherein determining a parameter score for a parameter further comprises entering a value for the selected parameter, normalizing the value of the selected parameter against statistical values for the selected parameter and multiplying the normalized parameter value by its associated influence value.

13. The computer-readable medium of claim 12, wherein the set of statistical values further includes at least one of: (i) a maximum value of the parameter for the sample set for wellbores; (ii) a minimum value of the parameter for the sample set for wellbores; (iii) a mean value of the parameter for the sample set for wellbores; (iv) a standard deviation of the parameter for the sample set for wellbores; and (v) a probability of “yes” for a binary distribution a distribution type for the parameter.

14. The computer-readable medium of claim 10, the method further comprising using a Monte Carlo simulation to obtain a ranking associated with a parameter and multiplying the ranking with a multiplier to determine the influence value for the parameter.

15. The computer-readable medium of claim 11, wherein the plurality of parameters includes wellbore parameters and reservoir parameters, further comprising at least one selected from the group consisting of: (i) summing wellbore parameter scores to obtain a well refracture score; and (ii) summing the reservoir parameter scores to obtain a reservoir refracture score.

16. The computer-readable medium of claim 10, wherein the refracture score is one of: (i) the reservoir refracture score; (ii) the wellbore refracture score; and (iii) a sum of the reservoir refracture score and the wellbore refracture score.

17. The computer-readable medium of claim 10 further comprising ranking the influence of the parameter based on at least one of: (i) an importance of the parameter toward the refracture decision; (ii) an availability of the parameter; and (iii) a placement of the parameter in a decision-making process.

18. The computer-readable medium of claim 10, further comprising performing refracture on the selected wellbore.

19. A method for selecting a wellbore for refracture, comprising:
selecting a parameter related the wellbore;
determining an influence value for the parameter;
estimating a refracture score for the wellbore based on a value of the selected parameter for the wellbore and the determined influence value; and
selecting the wellbore for refracture using the refracture score.

20. The method of claim 19, wherein estimating the refracture score further comprises normalizing the value of the selected parameter against statistical values for the selected parameter and multiplying the normalized parameter value by the determined influence value.
